(19) United States
(12) Patent Application Publication
(10) Pub. No.: US 2026/0095647 A1
(43) Pub. Date: Apr. 2, 2026

(54) INFORMATION PROCESSING APPARATUS, INFORMATION PROCESSING SYSTEM, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: MUNEYOSHI MAEDA, Kanagawa (JP)

(21) Appl. No.: 19/333,863

(22) Filed: Sep. 19, 2025

(30) Foreign Application Priority Data
Oct. 2, 2024 (JP) 2024-173478

(51) Int. Cl. H04N 23/63; G06T 5/50

(52) U.S. Cl. CPC H04N 23/635; G06T 5/50; G06T 2207/20221

(57) ABSTRACT

The information processing apparatus obtains information on a positional relationship between a user-wearable display apparatus that includes an imaging unit, and a user-operable imaging apparatus; determines display content to be displayed on the display apparatus based on the obtained positional relationship information; and output the determined display content, wherein the display content includes an image indicating a field of view of a user while not wearing the display apparatus or an image captured by an operation target of the user, and includes an image captured by the imaging unit, or is generated based on an image captured by the imaging apparatus.

### BACKGROUND

### Field of the Technology

The present disclosure relates to an information processing apparatus, an information processing system, a method for controlling the information processing apparatus, and a storage medium.

### Description of the Related Art

Recently, activities in a virtual world such as a metaverse displayed on a display apparatus worn on the head, such as Head Mounted Display (HMD), for example, have become common. A virtual world platform providing functions related to imaging, such as object imaging, imaging function setting, or operation of objects in the virtual world, by hand operation of controllers provided with the HMD is also known.

However, wearing a display apparatus on the head blocks the user's field of view of the real world. As a result, the user cannot see their hands, and the controllers are operated in a blind state. In addition, because an imaging operation using a controller differs in its operation method from the imaging apparatus in the real world, it is necessary to become accustomed to that operation method. Therefore, the user's burden increases. In addition, in the virtual world, there are a plurality of operation targets such as a virtual camera and an avatar corresponding to the user in the real world. Therefore, it is conceivable to switch the operation target, but such a switching operation also increases the user's burden.

Therefore, a method for detecting the positional relationship of objects and controllers in the real world and displaying the detected objects and controllers in the virtual world has been proposed (see Japanese Patent Laid-Open No. 2022-509769). In addition, a method for detecting an input from an HMD or controller and switching between an avatar operation and a virtual camera operation in a virtual world has been proposed (see Japanese Patent Laid-Open No. 2022-25473).

However, while the technique of Japanese Patent Laid-Open No. 2022-509769 makes it possible to ascertain general positions of objects and controllers in the virtual world, but detailed information, such as the shapes and position information of the hands and fingers used to operate the controllers, for example, is not displayed. Therefore, a button operation or the like on the controllers is a blind operation. Further, in Japanese Patent Laid-Open No. 2022-25473, an operation for switching that would not be performed in a real world situation is necessary. Therefore, in the techniques described in these patent documents, the burden on the user who operates the controllers is not reduced.

### SUMMARY

The present disclosure enables realization of a technique that reduces the operational burden related to imaging for a user wearing a display apparatus.

One aspect of the present disclosure provides an information processing apparatus comprising: one or more memory devices that store a set of instructions; and one or more processors that execute the set of instructions to: obtain information on a positional relationship between a user-wearable display apparatus that includes an imaging unit, and a user-operable imaging apparatus; determine display content to be displayed on the display apparatus based on the obtained positional relationship information; and output the determined display content, wherein the display content includes an image indicating a field of view of a user while not wearing the display apparatus or an image captured by an operation target of the user, and includes an image captured by the imaging unit, or is generated based on an image captured by the imaging apparatus, and wherein the positional relationship information includes at least one among: first information indicating that the imaging unit is light-shielded by the imaging apparatus, second information indicating that the display apparatus has approached a viewfinder of the imaging apparatus, and third information obtained by direct communication between the display apparatus and the imaging apparatus.

Another aspect of the present disclosure provides a method for controlling an information processing apparatus, the method comprising: obtaining information on a positional relationship between a user-wearable display apparatus that includes an imaging unit, and a user-operable imaging apparatus; determining display content to be displayed on the display apparatus based on the obtained positional relationship information; and outputting the determined display content, wherein the display content includes an image indicating a field of view of a user while not wearing the display apparatus or an image captured by an operation target of the user, and includes an image captured by the imaging unit, or is generated based on an image captured by the imaging apparatus, and wherein the positional relationship information includes at least one among: first information indicating that the imaging unit is light-shielded by the imaging apparatus, second information indicating that the display apparatus has approached a viewfinder of the imaging apparatus, and third information obtained by direct communication between the display apparatus and the imaging apparatus.

Still another aspect of the present disclosure provides a non-transitory computer-readable storage medium storing a program for causing a computer to execute each step in a method for controlling an information processing apparatus, the method comprising: obtaining information on a positional relationship between a user-wearable display apparatus that includes an imaging unit, and a user-operable imaging apparatus; determining display content to be displayed on the display apparatus based on the obtained positional relationship information; and outputting the determined display content, wherein the display content includes an image indicating a field of view of a user while not wearing the display apparatus or an image captured by an operation target of the user, and includes an image captured by the imaging unit, or is generated based on an image captured by the imaging apparatus, and wherein the positional relationship information includes at least one among: first information indicating that the imaging unit is light-shielded by the imaging apparatus, second information indicating that the display apparatus has approached a viewfinder of the imaging apparatus, and third information obtained by direct communication between the display apparatus and the imaging apparatus.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram of an imaging system according to one embodiment.

FIG. 2 is a diagram for explaining display content according to one embodiment.

FIGS. 3A and 3B are a flowchart of processing according to one embodiment.

FIG. 4 is a diagram for explaining display content according to one embodiment.

FIGS. 5A and 5B are a flowchart of processing according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

The present embodiment relates to display of an HMD when an imaging mode function is used in a virtual world, such as a metaverse, for example. Here, the virtual world indicates a two-dimensional or three-dimensional space represented by an image displayed on a computer, for example. The user wears the HMD and view the virtual world displayed on the HMD in a manner in which it is superimposed on the real world. In this way, augmented reality, virtual reality, or mixed reality can be experienced. Further, an avatar is a computer representation of the user themselves, for example. The avatar is commonly represented using two-dimensional or three-dimensional computer graphics rather than a captured image of the user themselves. In addition, the imaging mode function in the virtual world is a function for capturing an object that the user sees in the virtual world in a still image. It is generally assumed that a virtual object present within the angle of view of a virtual camera is captured from the virtual camera provided at the position of the avatar. Further, the imaging mode function may include a function that allows an imaging target object which is provided in video games and the like and the viewpoint information of a virtual camera to be freely arranged in the virtual world and imaging conditions (e.g., light source information and color information) to be freely set.

### Overview of Imaging System 100

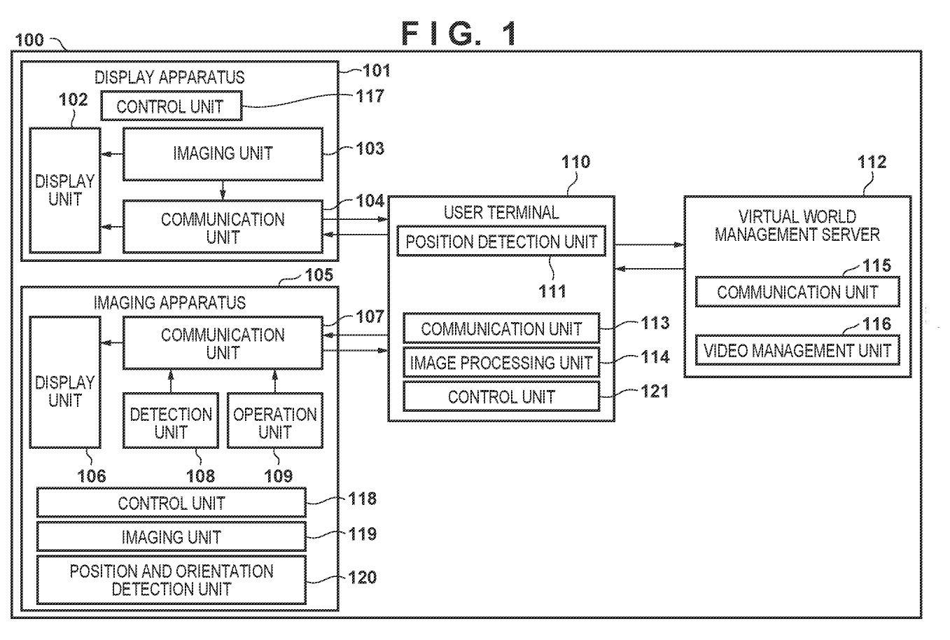

An example of a configuration of an imaging system 100 (an example of an "information processing system") will be described with reference to FIG. 1. The imaging system 100 is configured to include a display apparatus 101, an imaging apparatus 105, a user terminal 110 (an example of an "information processing apparatus"), and a virtual world management server 112.

The display apparatus 101 (an example of a "user-wearable display apparatus") is, for example, a head-mounted display (HMD) in the form of goggles, glasses, or a helmet. The display apparatus 101 includes a display unit 102 for displaying a virtual world, an imaging unit 103 for capturing the real world, a communication unit 104 for communicating with the user terminal 110, and a control unit 117 for comprehensively controlling the display apparatus 101, which includes each of these components.

The control unit 117 is constituted by, for example, a CPU and a storage medium such as a ROM, a RAM, or a Hard Disk Drive (HDD). The communication unit 104 is constituted by a communication module capable of short-range communication via infrared communication or a Bluetooth® standard (an example of "direct communication") and a communication module capable of connecting to a telephone communication network such as those for mobile phones and a Wi-Fi® network or the like. Further, the display unit 102 is constituted by a display module that displays video to a user, and the imaging unit 103 is constituted by an imaging module. An operating system (OS), various programs, various tables, and the like are stored in a storage medium, and the CPU loads a program stored in the storage medium into a work region of a main storage apparatus and executes the program. By each component and the like being controlled through the execution of such a program, each function matching a predetermined purpose, which will be described later, can be realized.

The imaging apparatus 105 (an example of a "user-operable imaging apparatus") is, for example, a digital camera, or a terminal having an imaging function such as a smartphone. The imaging apparatus 105 includes an imaging unit 119 for imaging a scene within the angle of view, a display unit 106 for displaying an image captured by the imaging unit 119, and a detection unit 108 that detects that the user has brought their eye close to the viewfinder. The imaging apparatus 105 also includes an operation unit 109 for receiving an operation input to the display unit 106 or an operation button, a communication unit 107 for communicating with the user terminal 110, and a position and orientation detection unit 120 for detecting a position and orientation of the imaging apparatus 105. The imaging apparatus 105 also includes a control unit 118 for comprehensively controlling the imaging apparatus 105, which includes these components. In the present embodiment, the imaging apparatus 105 is assumed to be a digital camera, for example. That is, the imaging apparatus 105 is configured to include, for example, a viewfinder, a display apparatus in the viewfinder, the display unit 106 on the back of the imaging apparatus 105, an eye sensor capable of detecting an approach of an eye to the viewfinder (an example of a "sensor capable of detecting an approach to the viewfinder"), and an operation button. The imaging apparatus 105 may be a smartphone. In such a case, a touch panel is provided over the entire front surface in the imaging apparatus 105.

The control unit 118 is configured to include, for example, a CPU and a storage medium such as a ROM, a RAM, or a Hard Disk Drive (HDD). The communication unit 107 is configured to include a communication module capable of short-range communication via infrared communication or a Bluetooth standard, for example, and a communication module capable of connecting to a telephone communication network such as those for mobile phones and a Wi-Fi network or the like. The imaging unit 119 is configured to include, for example, an imaging module and a sensor capable of detecting a position and orientation, such as an Inertial Measurement Unit (IMU). The position and orientation detection unit 120 is configured to include, for example, a sensor capable of position and orientation detection, and detects a position and orientation using sensor output thereof. The position and orientation detection unit 120 may obtain the position and orientation of the imaging apparatus 105 by using image data captured by the imaging unit 119.

An operating system (OS), various programs, various tables, and the like are stored in a storage medium of the imaging apparatus 105, and the CPU loads a program stored in the storage medium into a work region of a main storage apparatus and executes the program. Then, by each component and the like being controlled through the execution of such a program, each function matching a predetermined purpose, which will be described later, can be realized. In the following, the imaging apparatus 105, which appears in a video displayed by the display unit 102 of the display apparatus 101, will also be referred to as a virtual camera.

The user terminal 110 includes a communication unit 113 for communicating with the display apparatus 101, the imaging apparatus 105, and the virtual world management server 112. The user terminal 110 also includes a position detection unit 111 for detecting a positional relationship between the display apparatus 101 and the imaging apparatus 105, and an image processing unit 114 for rendering object data in accordance with rendering information and generating an image representing a virtual world. The user terminal 110 also includes a control unit 121 for comprehensively controlling the user terminal 110, which includes these components. The user terminal 110 may be provided with a display unit that includes a display module.

The control unit 121 is configured to include a CPU and a storage medium such as a ROM, a RAM, or a Hard Disk Drive (HDD). Further, a communication unit 113 is configured to include a communication module capable of short-range communication via infrared communication or the Bluetooth standard and a communication module capable of connecting to a telephone communication network such as those for mobile phones and a network such as Wi-Fi. An operating system (OS), various programs, various tables, and the like are stored in a storage medium, and the CPU loads a program stored in the storage medium into a work region of a main storage apparatus and executes the program. Then, by each component and the like being controlled through the execution of such a program, each function matching a predetermined purpose, which will be described later, can be realized.

The virtual world management server 112 is, for example, a computer, and is configured to include a communication unit 115 for communicating with the user terminal 110 and a video management unit 116 for managing images representing a virtual world. More specifically, the video management unit 116 manages display information to be displayed by the display unit 102 of the display apparatus 101. For example, the video management unit 116 sets object data to be displayed by the display unit 102 to a subject 200 detected in real world image data captured by the imaging apparatus 105. The video management unit 116 also generates rendering information for rendering the object data.

The video management unit 116 is configured to include a processor such as a CPU, a main storage apparatus such as a RAM or a ROM, and an auxiliary storage apparatus such as an EPROM, a hard disk drive, or a removable medium. The communication unit 115 is also configured to include a communication module (e.g., a Network Interface Card) capable of connecting to a network such as Wi-Fi. The removable medium may be, for example, a USB memory or a disk storage medium such as a CD or a DVD. The auxiliary storage apparatus stores an operating system (OS), various programs, various tables, and the like. By the CPU loading a program stored in the storage medium into a work region of the main storage apparatus and executes the program and each component and the like being controlled through the execution of such a program, each function matching a predetermined purpose, which will be described later, can be realized.

### Posture Pattern and Display Contents

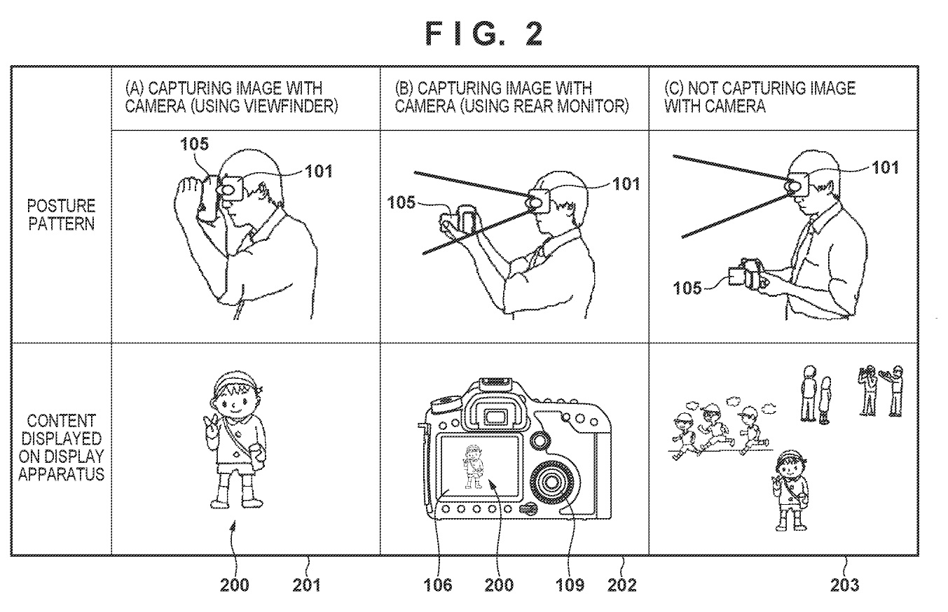

An example of display content to be displayed by the display unit 102 of the display apparatus 101 when the user wears the display apparatus 101 on the head will be described with reference to FIG. 2. (A) in FIG. 2 indicates a case where the posture of the user is a posture in which their eye is close to the viewfinder of the imaging apparatus 105 and they are capturing an image using the imaging apparatus 105. At this time, the subject 200 present in the angle of view of the imaging apparatus 105, for example, is displayed (display content 201) on the display unit 102 of the display apparatus 101. Thus, the user can recognize the subject 200 in the virtual world. The posture of the user indicated in (A) in FIG. 2 is also referred to as pattern 1.

(B) in FIG. 2 indicates a case where the posture of the user is a posture in which their eye is directed to the back of the imaging apparatus 105 and they are using the display unit 106 or the operation unit 109 provided on the back of the imaging apparatus 105 (hereinafter also referred to as pattern 2). At this time, the imaging apparatus 105 is present within the angle of view of the imaging unit 103 of the display apparatus 101. Such a posture is a posture equivalent to a posture in which an image is captured using the display unit 106 on the back of the imaging apparatus 105 in the real world. Further, it is conceivable that in such a posture the user is operating the display unit 106 or the operation unit 109 to perform menu setting or the like in addition to capturing an image. At this time, since an accurate operation would be difficult if the user does not know where their hands are positioned during operation, it is necessary to display the movement of the user's hands during a menu setting operation in the virtual world. Therefore, when the posture of the user is pattern 2, the display of the display unit 102 is switched to a video see-through method. That is, the imaging apparatus 105 displays objects present in the angle of view of the imaging unit 103 of the display apparatus 101 on the display unit 102 in real time. Then, a video of the subject 200 present within the angle of view of the actual imaging apparatus 105 (display content 202) can be superimposed on the display unit 106 on the back of the imaging apparatus 105 displayed in the virtual space (hereinafter, the imaging apparatus 105 displayed in the virtual space may be referred to as a virtual camera).

(C) in FIG. 2 indicates a case where the posture of the user is a posture in which they are looking away from the imaging apparatus 105, which they are holding, and the imaging apparatus 105 is not present in their line of sight, in other words, a posture in which the user is not using the imaging apparatus 105 (hereinafter, referred to as pattern 3). At this time, the imaging apparatus 105 is not present within the angle of view of the imaging unit 103 of 101 of the display apparatus. In this case, the display unit 102 of the display apparatus 101 can display all the objects present within the range of the angle of view of the imaging unit 103 (display content 203).

### Processing Example 1

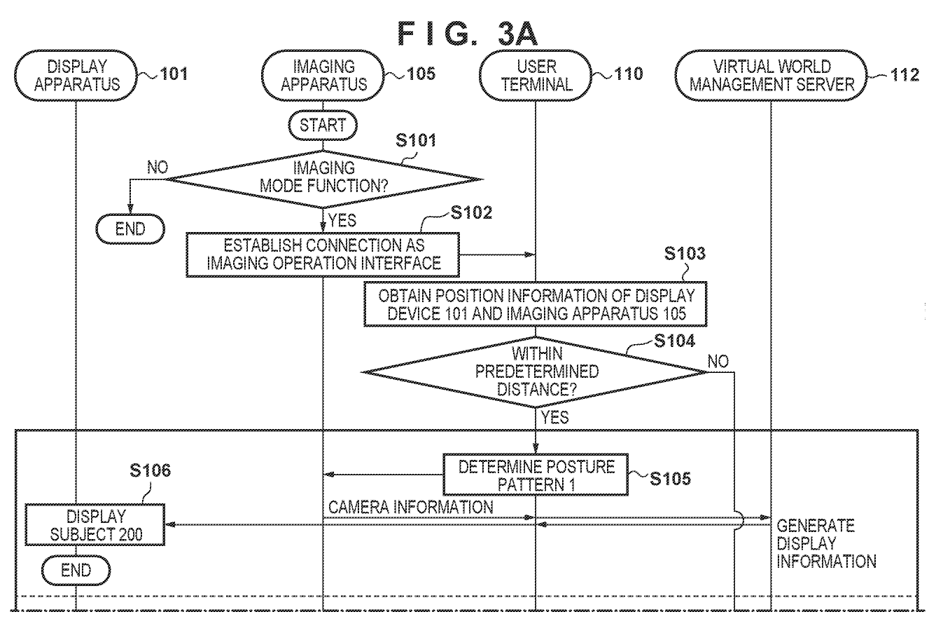

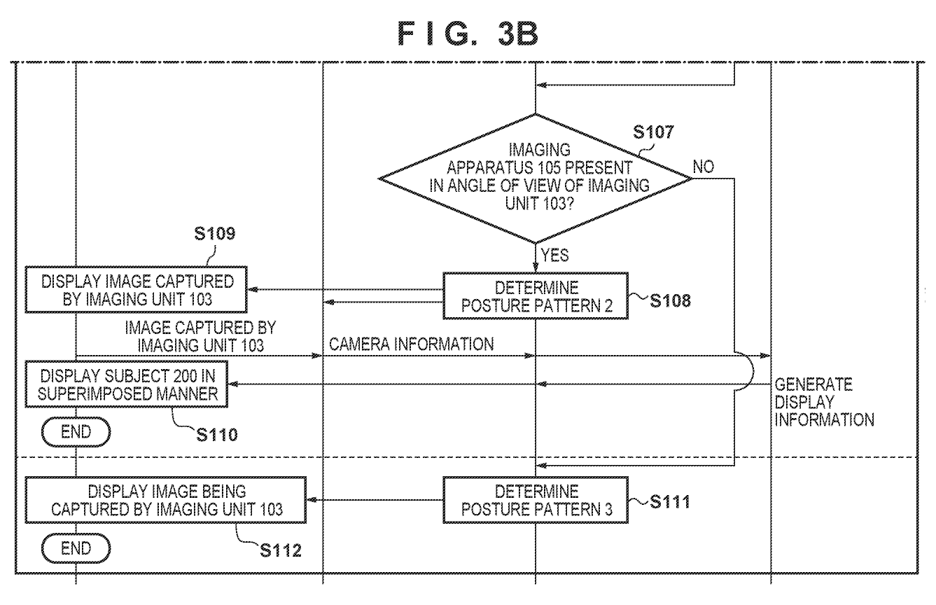

An example of a flowchart of sequence processing of the imaging system 100 will be described with reference to FIGS. 3A and 3B. Such processing is realized by the CPU of each apparatus constituting the imaging system 100 loading a program into the work region of the main storage apparatus and executing the program and each component and the like being controlled through the execution of the program.

In step S101, the control unit 118 of the imaging apparatus 105 determines whether the imaging mode function is being provided. Then, if it is determined that the control unit 118 is providing the imaging mode function, the processing proceeds to step S102, and otherwise, the processing is terminated. In step S102, the control unit 118 of the imaging apparatus 105 establishes a connection between the imaging apparatus 105 and the user terminal 110 as an interface for performing an imaging operation.

In step S103, in the user terminal 110, the position detection unit 111 (an example of an "obtaining unit") obtains position information (an example of "positional relationship information") of the display apparatus 101 and the imaging apparatus 105. More specifically, the position detection unit 111 receives an image captured by the imaging unit 103 of the display apparatus 101 via the communication unit 113. Alternatively, the position detection unit 111 receives a response signal of the eye sensor of the imaging apparatus 105 from the imaging apparatus 105 via the communication unit 113. Alternatively, the position detection unit 111 receives a record of an infrared short-range wireless communication or the like between the display apparatus 101 and the imaging apparatus 105 from the display apparatus 101 or the imaging apparatus 105 via the communication unit 113.

In step S104, the position detection unit 111 (an example of a "determination unit") determines whether the positional relationship between the display apparatus 101 and the imaging apparatus 105 is within a predetermined distance by using the position information obtained in step S103. The predetermined distance is a value indicating that the display apparatus 101 and the imaging apparatus 105 are close, and is, for example, a few centimeters. Then, if the position detection unit 111 determines that the positional relationship is that they are within the predetermined distance, the processing proceeds to step S105, and otherwise, the processing proceeds to step S107. More specifically, if an image captured by the imaging unit 103 is received, the position detection unit 111 determines whether the image is in a light-shielded state. Then, if it is determined that it is in a light-shielded state, the position detection unit 111 assumes that the imaging unit 103 is covered by the imaging apparatus 105, and determines that the distance between the display apparatus 101 and the imaging apparatus 105 is within the predetermined distance.

Alternatively, if a response signal of the eye sensor of the imaging apparatus 105 is received, the position detection unit 111 determines that the distance between the display apparatus 101 and the imaging apparatus 105 is within the above predetermined distance. Alternatively, if a record of short-range wireless communication such as infrared communication between the display apparatus 101 and the imaging apparatus 105 is received and the wireless communication is successful, the position detection unit 111 determines that the distance between the display apparatus 101 and the imaging apparatus 105 is within the above predetermined distance.

In step S105, the position detection unit 111 determines that the posture of the user is pattern 1 (see FIG. 2), and the processing proceeds to step S106. In step S106, the display unit 102 of the display apparatus 101 displays the subject 200 within the angle of view of the imaging apparatus 105. More specifically, the communication unit 113 of the user terminal 110 transmits information indicating that the posture of the user is pattern 1 to the imaging apparatus 105. Then, the communication unit 107 of the imaging apparatus 105 transmits a video captured by the imaging apparatus 105, and the position and orientation information and camera setting information (e.g., sensor size and zoom magnification) (these are referred to as camera information) of the imaging apparatus 105 to the user terminal 110. The communication unit 113 of the user terminal 110 further transmits the camera information to the virtual world management server 112. The communication unit 115 of the virtual world management server 112 receives the position and orientation information and the camera setting information. Then, the video management unit 116 detects the subject 200, which is captured in the video, based on the received camera information and sets the subject 200 as object data. Such detection may be performed, for example, by a machine learning method.

The video management unit 116 also generates rendering information for a three-dimensional video of the subject 200, for example, by using the position and orientation information. Alternatively, the video management unit 116 generates rendering information including contrast or color gradation of the image in accordance with the sensor size of the imaging apparatus 105, for example. Alternatively, the video management unit 116 generates rendering information for a video in which the subject 200 is enlarged or reduced, for example, in accordance with the zoom information of the imaging apparatus 105. In this way, the video management unit 116 generates display information such as object data to be displayed by the display apparatus 101 and rendering information. The communication unit 115 transmits the display information to the user terminal 110.

In the user terminal 110, the communication unit 113 receives the display information. The image processing unit 114 renders the object data included in the received display information in accordance with the rendering information. Then, the communication unit 113 (an example of an "output unit") transmits the rendered image data to the display apparatus 101. Then, in the display apparatus 101, the communication unit 104 receives the rendered image data, and the display unit 102 displays the image data.

If the position detection unit 111 determines in step S104 that the positional relationship between the display apparatus 101 and the imaging apparatus 105 exceeds the predetermined distance, in step S107 the position detection unit 111 obtains an image captured by the imaging unit 103 of the display apparatus 101, via the communication unit 113. Then, the position detection unit 111 determines whether the imaging apparatus 105 configured to allow the user to operate the display unit 106 or the operation unit 109 is present within the range of the angle of view of the imaging unit 103. "Configured to allow operation" indicates, for example, that the user's hands are displayed in an image in a manner in which they overlap the imaging apparatus 105. Then, if the position detection unit 111 determines that the imaging apparatus 105 is present, the processing proceeds to step S108, and otherwise, the processing proceeds to step S111. Such a determination is realized by identifying the imaging apparatus 105 in the image by, for example, a machine learning method.

In step S108, the position detection unit 111 determines that the posture of the user is pattern 2, and the processing proceeds to step S109. In step S109, the communication unit 113 of the user terminal 110 transmits a request to switch the display method of the display unit 102 to the video see-through method to the display apparatus 101. The communication unit 104 of the display apparatus 101 receives this request, and the control unit 117 performs control to switch the display method of the display unit 102 to the video see-through method. That is, the display unit 102 of the display apparatus 101 displays a real-time image being captured by the imaging unit 103 of the display apparatus 101. Further, in step S110, the display apparatus 101 obtains the display information of the subject 200 present within the angle of view of the imaging apparatus 105 in the same manner as in step S106. Then, the display unit 102 displays the subject 200 in a superimposed manner on the display unit 106 on the back of the virtual camera, which appears in the image being displayed in real time. The image data of the subject 200 is generated in the virtual world management server 112. That is, the communication unit 115 of the virtual world management server 112 receives an image captured by the imaging unit 103 from the display apparatus 101. Then, the virtual world management server 112 estimates the position of the display unit 106 of the imaging apparatus 105 by using the image captured by the imaging unit 103. Then, the image data in which the subject 200 is arranged at the estimated position is generated. In order to improve the accuracy of estimating the position of the display unit 106, a marker component may be provided on the display unit 106 on the back of the imaging apparatus 105 in the real world. Then, the processing is terminated.

Meanwhile, if the position detection unit 111 determines in step S107 that the imaging apparatus 105 is not present in the image captured by the imaging unit 103, in step S111 the position detection unit 111 determines that the posture of the user is pattern 3. Then, in step S112, the communication unit 113 of the user terminal 110 makes a request to the display apparatus 101 to display an image being captured by the imaging unit 103. The communication unit 104 of the display apparatus 101 receives this request, and the display unit 102 displays a real-time image captured by the imaging unit 103 of the display apparatus 101.

### Effect/Advantage Aspect

According to the imaging system 100 as described above, the video displayed by the display unit 102 of the display apparatus 101 is automatically switched in accordance with the posture of the user. In addition, the video satisfactorily reproduces the real-world field of view that would be visible to the user if they were not wearing the display apparatus 101. Therefore, the operational burden related to imaging for the user while wearing the display apparatus 101 is reduced.

### Modification

### Posture Pattern and Display Contents

In a modification, description will be given focusing on portions that are different from the above embodiment. The position detection unit 111 according to the modification also determines the positional relationship between the display apparatus 101 and the imaging apparatus 105 similarly to the above embodiment. Then, the position detection unit 111 determines that the posture of the user falls under one of the above three patterns based on the positional relationship. Further, in the modification, an operation on the imaging apparatus 105 in the real world is reflected in the virtual world. Further, the target of this operation is automatically switched in accordance with the posture pattern.

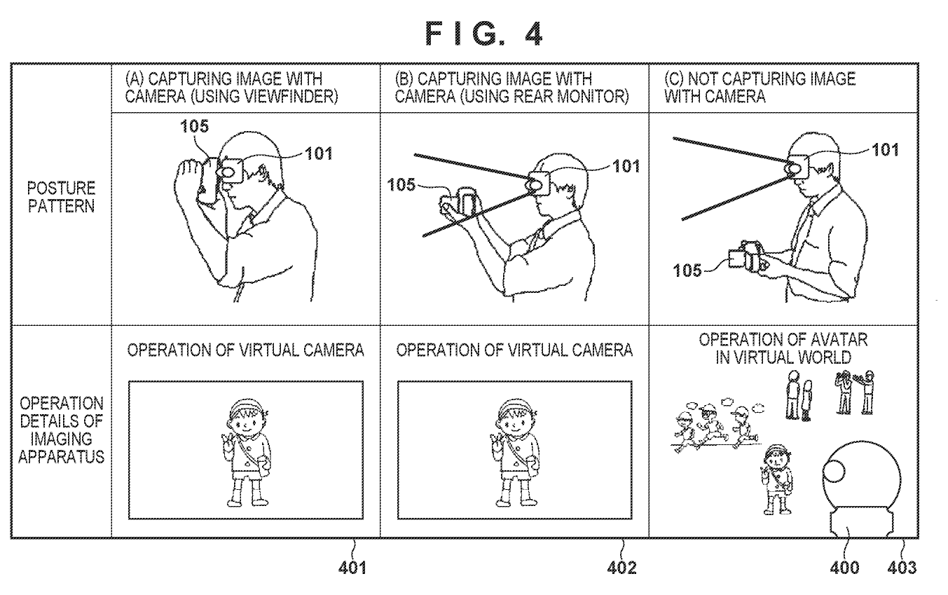

Switching of the operation target will be described with reference to FIG. 4. (A) in FIG. 4 indicates a case where the posture of the user is a posture in which they are capturing an image using the viewfinder of the imaging apparatus 105. At this time, the subject 200 present in the angle of view of the imaging apparatus 105, for example, is displayed (display content 401) on the display unit 102 of the display apparatus 101. Further, the control unit 118 sets the imaging apparatus 105 as the operation target for the operation unit 109. That is, the control unit 118 sets the operation target in the virtual world as the virtual camera. The posture of the user indicated in (A) in FIG. 4 is also referred to as pattern 1.

(B) in FIG. 4 indicates a case where the posture of the user is a posture in which they are capturing an image using the display unit 106 on the back of the imaging apparatus 105 (hereinafter also referred to as pattern 2). At this time, the subject 200 present in the angle of view of the imaging apparatus 105, for example, is displayed (display content 402) on the display unit 102 of the display apparatus 101. Further, the control unit 118 sets the operation target of the operation unit 109 in the virtual world to the virtual camera similarly to the case of pattern 1.

(C) in FIG. 4 indicates a case where the posture of the user is a posture in which they are at least not capturing an image using the imaging apparatus 105 (hereinafter also referred to as pattern 3). At this time, a scene present in the angle of view of the imaging unit 103 of the display apparatus 101, for example, is displayed (display content 403) on the display unit 102 of the display apparatus 101. Further, the control unit 118 sets the imaging unit 103 of the display apparatus 101 as the operation target for the operation unit 109. That is, the control unit 118 sets the target of operation input in the virtual world as an avatar 400 corresponding to the user and provided in the virtual world or as the viewpoint of the user.

### Processing Example 2

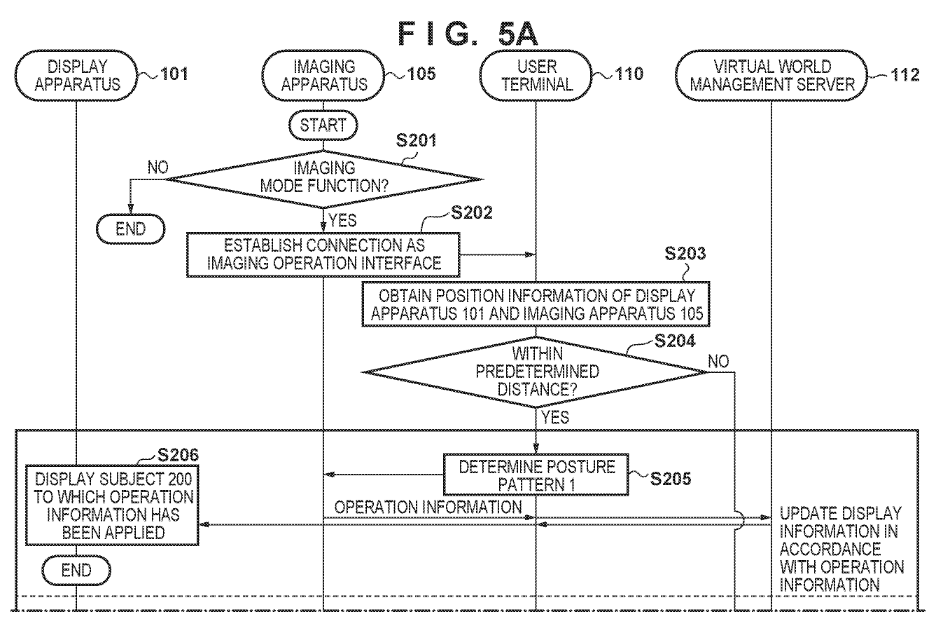

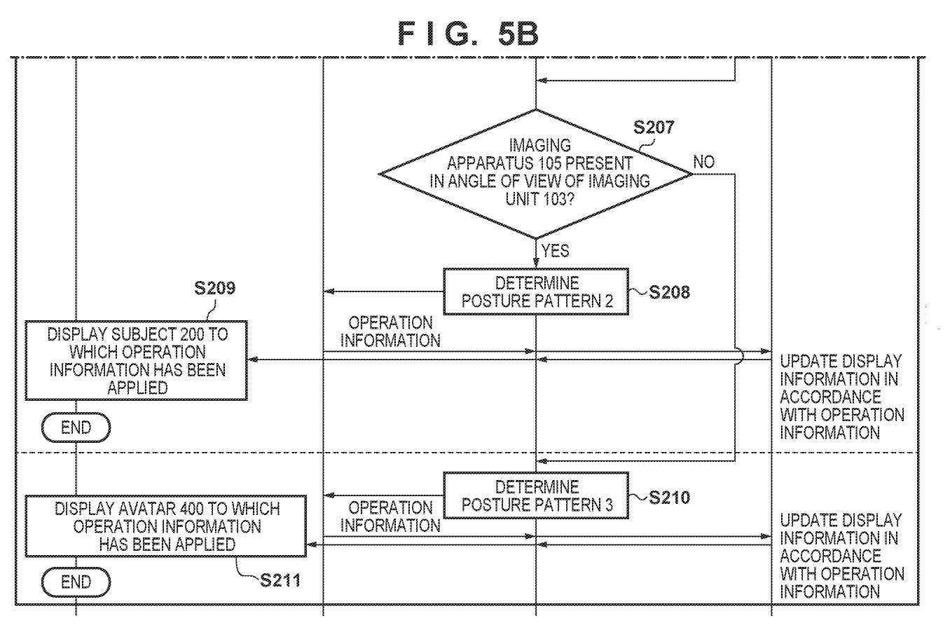

Another example of a flowchart of sequence processing of the imaging system 100 will be described with reference to FIGS. 5A and 5B. Such processing is realized by the CPU of each apparatus constituting the imaging system 100 loading a program into the work region of the main storage apparatus and executing the program and each component and the like being controlled through the execution of the program. Since steps S201 to S205, S207, S208, and S210 correspond to steps S101 to S105, S107, S108, and S111, respectively, description thereof will be omitted.

In step S206, the control unit 118 of the imaging apparatus 105 receives an operation input to the display unit 106 or the operation unit 109. Here, operation information that the control unit 118 receives is, for example, setting information for imaging, such as the zoom magnification of the imaging apparatus 105. The control unit 118 changes the settings of the imaging mode function by using the operation information. The control unit 118 of the imaging apparatus 105 also receives the position and orientation information of the imaging apparatus 105 detected by the position and orientation detection unit 120 as the operation information. The control unit 118 also obtains from the user terminal 110 that the posture of the user is pattern 1 via the communication unit 107. Then, the control unit 118 sets the above target of operation on the imaging apparatus 105 to the virtual camera. Then, the communication unit 107 transmits the operation information, which includes operation target information, to the user terminal 110. The communication unit 113 of the user terminal 110 further transmits the operation information to the virtual world management server 112.

Then, in the virtual world management server 112, the communication unit 115 receives the operation information. The video management unit 116 stores the received operation information as operation information for the virtual camera in the storage medium. Further, if the operation information is already stored in the storage medium, the video management unit 116 updates the operation information and stores it. Then, the video management unit 116 applies the latest operation information to the virtual camera and generates display information to be displayed on the display apparatus 101. More specifically, the video management unit 116 detects the subject 200, which is included in captured data captured by the imaging apparatus 105, and sets the subject 200 as object data. Then, when the setting information such as the zoom magnification is updated, the video management unit 116 generates display information such as an object to which the updated setting information has been applied and rendering information. Further, when the position and orientation information of the imaging apparatus 105 is updated, the updated position and orientation information is applied to captured data captured by the imaging apparatus 105 to generate display information such as an object and rendering information. Subsequent processes are performed similarly to step S106. The display unit 102 of the display apparatus 101 displays a video in which an operation on the operation unit 109 of the user has been applied to the subject 200. Similar processing is performed in step S209.

Meanwhile, in step S211, the control unit 118 of the imaging apparatus 105 receives an operation input to the display unit 106 or an operation button as operation information. The control unit 118 also receives the position and orientation information of the imaging apparatus 105 detected by the position and orientation detection unit 120 as the operation information. The control unit 118 also obtains from the user terminal 110 that the posture of the user is pattern 3 via the communication unit 107. Then, the control unit 118 sets the above operation target for the imaging apparatus 105 to the avatar 400 in the virtual world. Then, the communication unit 107 transmits the operation information, which includes operation target information, to the user terminal 110. The communication unit 113 of the user terminal 110 further transmits the operation information to the virtual world management server 112.

Then, in the virtual world management server 112, the communication unit 115 receives the operation information. The communication unit 115 also receives an image captured by the imaging unit 103 of the display apparatus 101. Then, the video management unit 116 combines the captured data captured by the imaging unit 103 of the display apparatus 101 and an image of the avatar 400 corresponding to the user. The position where the avatar 400 is placed is, for example, a region in which no object appears. Alternatively, the virtual world management server 112 may provide a virtual user viewpoint in the image instead of the avatar 400. Then, the virtual world management server 112 generates rendering information in which the received operation information has been applied to the avatar 400. That is, when an operation of pressing a button indicating a right direction is accepted, for example, the control unit 118 of the imaging apparatus 105 generates an image obtained by moving an object appearing in the right portion of an image captured by the imaging unit 103 of the display apparatus 101 to center. The video management unit 116 stores the operation information as operation information for the avatar 400 in the storage medium. Further, if the operation information is already stored in the storage medium, the video management unit 116 updates the operation information and stores it. Subsequent processes are performed similarly to step S206. The display unit 102 of the display apparatus 101 displays a video in which an operation on the operation unit 109 of the user has been applied to the avatar 400.

### Effect/Advantage Aspect

According to the imaging system 100 according to the modification, when the posture of the user is a posture in which their eye is close to the viewfinder of the imaging apparatus 105 (pattern 1), the operation target in the virtual world is automatically set to the virtual camera. Similarly, in a case of a posture in which the display unit 106 on the back of the imaging apparatus 105 is being used (pattern 2), the operation target is also set to the virtual camera. Further, the subject 200 imaged by the imaging apparatus 105 is displayed on the display unit 102 of the display apparatus 101. Therefore, by operating the operation unit 109, the user can easily capture an image using the virtual camera and perform imaging settings.

Meanwhile, when the posture of the user is a posture in which they are not using the imaging apparatus 105 (pattern 3), the operation target in the virtual world is automatically set to the avatar 400. Further, the avatar 400 is displayed on the display unit 102 of the display apparatus 101. Therefore, the user can search for an imaging target in the virtual world by changing the viewpoint of the avatar 400 through operation of the operation unit 109 while wearing the display apparatus 101. Thus, according to the imaging system 100 according to the modification, the operational burden related to imaging for the user while wearing the display apparatus 101 is also reduced.

According to the present disclosure, it is possible to provide a technique that makes it possible to reduce an operational burden related to imaging for the user wearing the display apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-173478, filed October 2, 2024, which is hereby incorporated by reference herein in its entirety.

What is claimed is:

1. An information processing apparatus comprising:
one or more memory devices that store a set of instructions; and
one or more processors that execute the set of instructions to:
obtain information on a positional relationship between a user-wearable display apparatus that includes an imaging unit, and a user-operable imaging apparatus;
determine display content to be displayed on the display apparatus based on the obtained positional relationship information; and
output the determined display content,
wherein the display content
includes an image indicating a field of view of a user while not wearing the display apparatus or an image captured by an operation target of the user, and
includes an image captured by the imaging unit, or is generated based on an image captured by the imaging apparatus, and
wherein the positional relationship information includes at least one among:
first information indicating that the imaging unit is light-shielded by the imaging apparatus,
second information indicating that the display apparatus has approached a viewfinder of the imaging apparatus, and
third information obtained by direct communication between the display apparatus and the imaging apparatus.

2. The information processing apparatus according to claim 1, wherein
the one or more processors execute instructions in the one or more memory devices to:
in a case where the first information or the second information is obtained, or in a case where the third information is obtained and a distance between the display apparatus and the imaging apparatus obtained based on the obtained third information is within a predetermined distance,
determine an image captured by the imaging apparatus to be the display content.

3. The information processing apparatus according to claim 2, wherein
the one or more processors execute instructions in the one or more memory devices to:
in a case where fourth information indicating that the imaging apparatus is included in a first image captured by the imaging unit is obtained as the positional relationship information,
determine the first image, and a second image captured by the imaging apparatus to be superimposed on a display unit on a back of the imaging apparatus included in the first image to be the display content.

4. The information processing apparatus according to claim 3, wherein
the display unit or an operation unit included in the imaging apparatus included in the first image is configured to be operable by the user.

5. The information processing apparatus according to claim 4, wherein
the one or more processors execute instructions in the one or more memory devices to:
in a case where the positional relationship information, which does not include any of the first information, the second information, the third information, and the fourth information, is obtained,
determine an image captured by the imaging unit to be the display content.

6. An information processing system comprising:
the information processing apparatus according to claim 1; and
the imaging apparatus comprising:
one or more memory devices that store a set of instructions; and
one or more processors that execute the set of instructions to:
accept an operation of the user, and set an operation target in a virtual world; and
in a case where the first information or the second information is obtained, in a case where the third information is obtained and a distance between the display apparatus and the imaging apparatus obtained based on the obtained third information is within a predetermined distance, or in a case where fourth information indicating that the imaging apparatus is included in an image captured by the imaging unit is obtained as the positional relationship information in the information processing apparatus,
set the operation target of the imaging apparatus to the imaging apparatus,
wherein the one or more processors execute instructions in the one or more memory devices in the information processing apparatus to:
determine an image in which an operation accepted by the imaging apparatus has been reflected in captured data captured by the imaging apparatus to be the display content,
wherein the one or more processors execute instructions in the one or more memory devices in the imaging apparatus to:
in a case where the positional relationship information, which does not include any of the first information, the second information, the third information, and the fourth information, is obtained in the information processing apparatus,
set the operation target of the imaging apparatus to the display apparatus, and
wherein the one or more processors execute instructions in the one or more memory devices in the information processing apparatus to:
determine an image in which an operation accepted by the imaging apparatus has been reflected in captured data captured by the imaging unit of the display apparatus to be the display content.

7. A method for controlling an information processing apparatus, the method comprising:
obtaining information on a positional relationship between a user-wearable display apparatus that includes an imaging unit, and a user-operable imaging apparatus;
determining display content to be displayed on the display apparatus based on the obtained positional relationship information; and
outputting the determined display content,
wherein the display content
includes an image indicating a field of view of a user while not wearing the display apparatus or an image captured by an operation target of the user, and
includes an image captured by the imaging unit, or is generated based on an image captured by the imaging apparatus, and
wherein the positional relationship information includes at least one among:
first information indicating that the imaging unit is light-shielded by the imaging apparatus,
second information indicating that the display apparatus has approached a viewfinder of the imaging apparatus, and
third information obtained by direct communication between the display apparatus and the imaging apparatus.

8. A non-transitory computer-readable storage medium storing a program for causing a computer to execute each step in a method for controlling an information processing apparatus, the method comprising:
obtaining information on a positional relationship between a user-wearable display apparatus that includes an imaging unit, and a user-operable imaging apparatus;
determining display content to be displayed on the display apparatus based on the obtained positional relationship information; and
outputting the determined display content,
wherein the display content
includes an image indicating a field of view of a user while not wearing the display apparatus or an image captured by an operation target of the user, and
includes an image captured by the imaging unit, or is generated based on an image captured by the imaging apparatus, and
wherein the positional relationship information includes at least one among:
first information indicating that the imaging unit is light-shielded by the imaging apparatus,
second information indicating that the display apparatus has approached a viewfinder of the imaging apparatus, and
third information obtained by direct communication between the display apparatus and the imaging apparatus.
